(19) United States
(12) Patent Application Publication
(10) Pub. No.: US 2025/0338806 A1
(43) Pub. Date: Nov. 6, 2025

(54) Rack Assembly

(71) Applicant: BL United, LLC, North Little Rock, AR (US)

(72) Inventor: Luis Campos, North Little Rock, AR (US)

(73) Assignee: BL United, LLC, North Little Rock, AR (US)

(21) Appl. No.: 19/196,675

(22) Filed: May 1, 2025

Related U.S. Application Data
(60) Provisional application No. 63/641,144, filed on May 1, 2024.

(51) Int. Cl. A01G 31/06; A01G 7/04

(52) U.S. Cl. CPC A01G 31/06; A01G 7/045

(57) ABSTRACT

A rack assembly provides a portable support structure for supporting and holding one or more support members, one or more light holders, and a storage container for growing plants in vertical farming with minimal to no soil. Sections of the rack assembly are selectively adjustable. The rack assembly is preferably adapted for vertical farming by using one or more pipes or support members, each of which contain one or more plants within one or more pot holders, with at least one or more light holders with a light fixture that provides adequate lighting for the plants to grow, and with the storage container holding water and/or nutrients for plant growth.

### CROSS-REFERENCE TO RELATED APPLICATIONS

This application claims the benefit of pending U.S. Provisional Patent Application No. 63/641,144, filed on May 1, 2024, and is a continuation-in-part of pending U.S. patent application Ser. No. 29/877,209, filed on Jun. 2, 2023, and a continuation-in-part of pending U.S. patent application Ser. No. 18/488,868, filed on Oct. 17, 2023, which claims the benefit of U.S. Provisional Patent Application No. 63/418,036, filed on Oct. 21, 2022, each of which is incorporated herein by reference in its entirety.

### FEDERALLY SPONSORED RESEARCH AND DEVELOPMENT Not applicable.

### BACKGROUND OF THE INVENTION

### 1. Field of the Invention

The present invention generally relates to a rack assembly used as a portable stand for vertical farming, with the rack assembly having a frame, at least one support member, at least one pot holder, at least one light holder, at least one light source, and a storage container. More particularly, the rack assembly is a portable stand preferably used in vertical farming, wherein the rack assembly is a portable stand or frame for supporting a plurality of support members each of which contains plants within one or more pot holders, at least one light holder having at least one light fixture for illuminating and providing heat for the plants, and a storage container for containing water and/or nutrients fed to the plants.

### 2. Description of Arguably Related Art Including Information Disclosed for 37 CFR 1.97 and 1.98

Conventional rack assemblies for growing plants and food produce vertically or without soil often require multiple, complex components to assemble. Some of these products are too heavy, bulky, and cumbersome for use by the average consumer, or cannot be scaled for commercial or large quantity use in growing plants and food produce. Many conventional assemblies have one or more upstanding support members that include one or more pot holders. These support members are essentially pipes or tubes. The support members may be configured and attached to a stand or a frame. These support members often lack options for individual spacing for the pot holders on or in each support member. In those examples, conventional pot holders are affixed to the support member and are evenly spaced and arranged along the length of the support member. The interior of each of these conventional pot holders allow for plant growth, nutrient absorption, and drainage.

A problem arises when certain plants require more spacing between the conventionally spaced and affixed pot holders. Another problem is that a user cannot maximize the amount of pot holders that are used with an individual support member because many of the conventional pot holders are affixed and do not allow for selective placement and arrangement along the support member according to the user's desired spacing requirements for specific plants. Another problem is that nutrient media and a water source may not be easily stored in a centralized storage container on the assembly for access by all the plants grown in the various pot holders on the support members. Yet another problem is the lack of an illumination holder having a light source or illumination member that is selectively adjustable and used for the needs of the plants in the pot holders on each individual support member.

A need exists for a rack assembly that is portable and adjustable for supporting one or more pipes or support members, one or more pot holders, one or more light fixtures, one or more light holders, and a storage container for storing and accessing water and nutrient media, preferably for growing plants for vertical farming.

A need exists for a rack assembly having one or more light fixtures coupled to one or more light holders for providing at least a light source, with each of light holder being independently and selectively adjustable in relation to each individual support member supporting one or more pot holders containing the plants.

A need exists for a rack assembly having a storage container that contains nutrient media, including water, that feeds and hydrates the plants grown within the pot holders on the support members of the rack assembly.

### SUMMARY OF THE INVENTION

Due to the described disadvantages inherent in the known types of rack assemblies for vertical farming and hydroponic farming, the present invention provides a new and improved rack assembly and method for planting and growing food produce, flowers, and plants (collectively, “plants”) having variable growth heights and spacing needs within one or more pot holders on one or more support members while also providing a light source from one or more slidably adjustable light fixtures and a nutrient source stored in a storage container for the plants. It is understood that the present invention is not limited in its application to the details of construction and to the arrangement of the components described in the following illustrated drawing or in the detailed description.

In general, the invention discloses a rack assembly comprising a portable frame, at least one support member, at least one pot holder for holding plants, at least one light holder, at least one light fixture, and a storage container containing at least water and nutrient media for the plants. The rack assembly is essentially a portable stand or frame for vertical farming, wherein the rack assembly has a portable stand or frame for holding a plurality of support members each of which contains plants within one or more pot holders selectively using one or more spacers for custom spacing and arranging of the pot holders along each support member, a light source for illuminating and providing warmth for the plants, and a storage container for containing at least water and nutrient media drawn through tubing to the top of the support members for dispersing to the plants within the pot holders.

In an embodiment, the invention is a rack assembly for vertical farming of plants, flowers, and food produce, the rack assembly comprising (including or having):
(a) a frame for supporting at least one light holder, at least one support member, and a storage container, with the frame being movable and lightweight for easy transport;
(b) each of the at least one light holders having a cross bar removably coupled to a column abutting a fixture bracket, with an adjustable member on the column for adjusting the position of the column inwardly or outwardly along the length of the cross bar;
(c) each of the at least one support members being removably attached to the frame with an S-hook fastener; and
(d) the storage container having the lid and a container body, with the lid defining a plurality of pipe holders, at least one cutout, and one or more gaps, with the plurality of pipe holders for receiving a lower end of each of the at least one support member.

It is an object of this invention to a rack system that is portable and adjustable for supporting one or more pipes or support members, one or more pot holders, one or more light fixtures, one or more light holders, and a storage container for storing and accessing water and nutrient media, preferably for growing plants for vertical farming.

It is another object of this invention to a rack assembly having one or more light fixtures coupled to one or more light holders for providing at least a light source, with each of light holder being independently and selectively adjustable in relation to each individual support member supporting one or more pot holders containing the plants.

It is yet another object of this invention to a rack assembly having a storage container that contains nutrient media, including water, that feeds and hydrates the plants grown within the pot holders on the support members of the rack assembly.

These and other aspects, objects, embodiments, and advantages of the invention will become apparent from the accompanying drawing and the following detailed description of the preferred embodiments of the invention.

### BRIEF DESCRIPTION OF THE SEVERAL VIEWS OF THE DRAWING

The invention may be more readily described by reference to the accompanying drawing figures and the following description of the drawing figures. The reference numbers apply to each embodiment of the invention. In the drawing:

FIG. 1 is a perspective view of a rack assembly, showing my new design;

FIG. 2 is a front elevation view thereof;

FIG. 3 is a rear elevation view thereof;

FIG. 4 is a top plan view thereof;

FIG. 5 is a bottom plan view thereof;

FIG. 6 is a left side elevation view thereof;

FIG. 7 is a right side elevation view thereof;

FIG. 8 is an exploded view of a section of the rack assembly of FIG. 1 thereof, showing a plurality of light holders being assembled;

FIG. 9 is an exploded view of one of the light holders in a disassembled configuration;

FIG. 10 is another exploded view of the plurality of light holders on the frame, shown in use with a plurality of light fixtures;

FIG. 11 is a perspective view of FIG. 1 thereof, shown in use with a plurality of light fixtures and a plurality of support members assembled on the frame;

FIG. 12 is an exploded view of FIG. 12, thereof showing close up of section of the storage container with the lid removed in environment with a water pipe tubing and a power cable for pump installations;

FIG. 13 is another perspective view of FIG. 1, showing the configuration of the rack assembly with the lid of the storage container removed;

FIG. 14 is a top plan view thereof;

FIG. 15 perspective view of FIG. 1, with the plurality of light fixtures and the plurality of pipes in an assembled configuration on the rack assembly;

FIG. 16 is another perspective view of FIG. 15, but with an alternative number of the plurality of light fixtures, the plurality of pipes, and one of the tubing being installed on the rack assembly;

FIG. 17 is a front elevation view of FIG. 15;

FIG. 18 is a rear elevation view of FIG. 15;

FIG. 19 is a top plan view of FIG. 15;

FIG. 20 is a bottom plan view of FIG. 15;

FIG. 21 is a left side elevation view of FIG. 15;

FIG. 22 is a right side elevation view of FIG. 15;

FIG. 23 is an exploded view of one a light fixture coupled to one of the light holders, and two light fixtures in a disassembled configuration; and

FIG. 24 is an exploded view of a disassembled configuration of the rack assembly, showing one of the plurality of support members having a pot holder with one pot and a plurality of stacked spacers, with the upper portion of the support member coupling to the frame with the S-hook.

The broken lines represent environment and form no part of the claimed design.

### DETAILED DESCRIPTION OF THE INVENTION

The present invention, preferred embodiments of the invention, and the accompanying drawing figures as described herein should not be construed as limited to the illustrated drawing. Rather the illustrated embodiment(s) are detailed to provide a thorough disclosure suitable to convey the scope of the invention to those skilled in the art. For the sake of simplicity, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

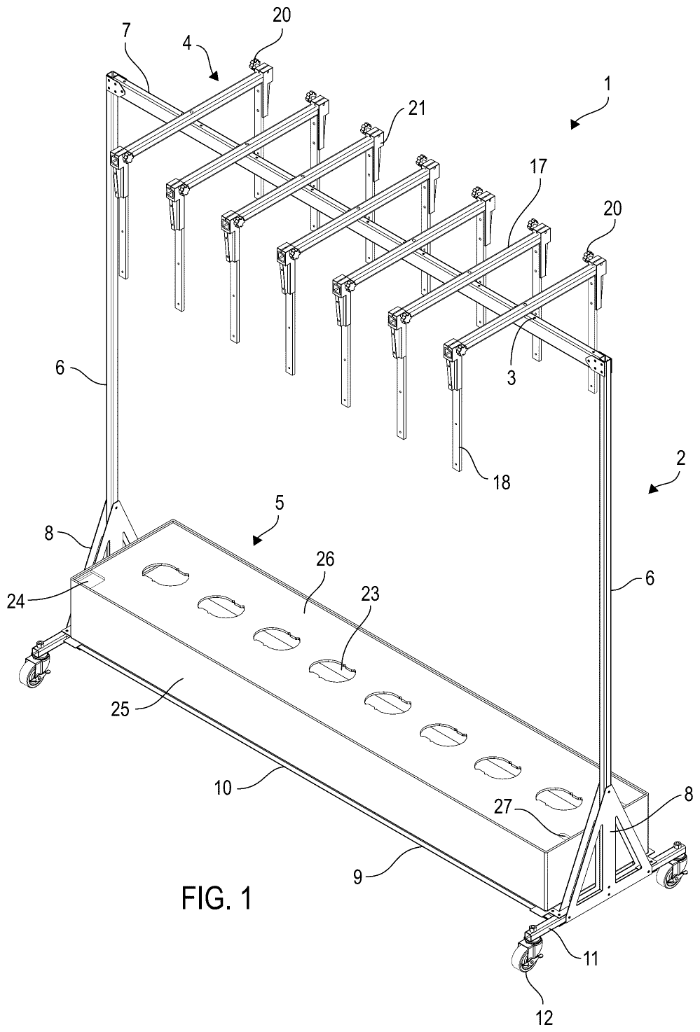

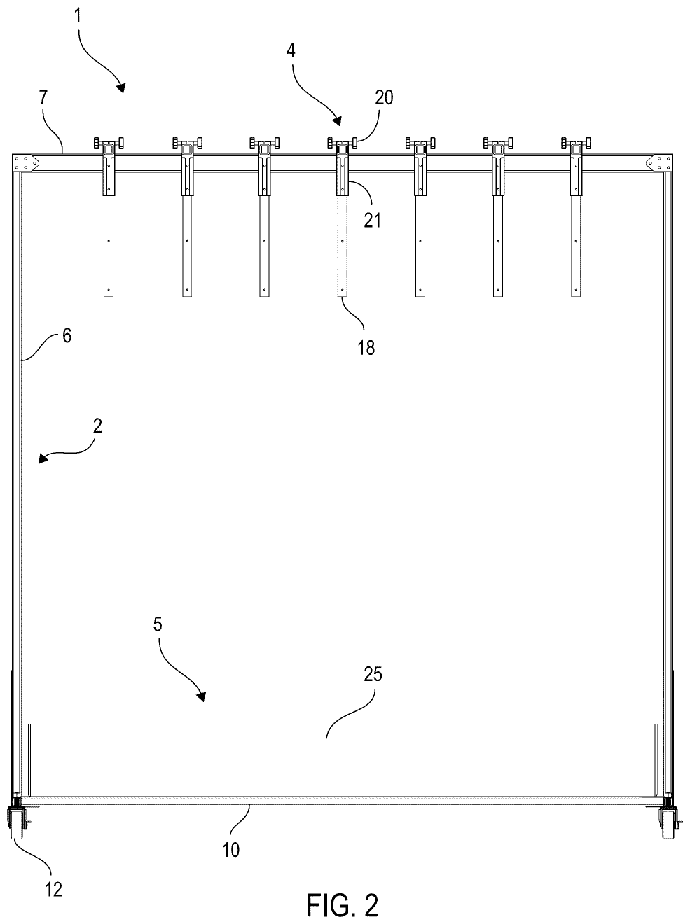

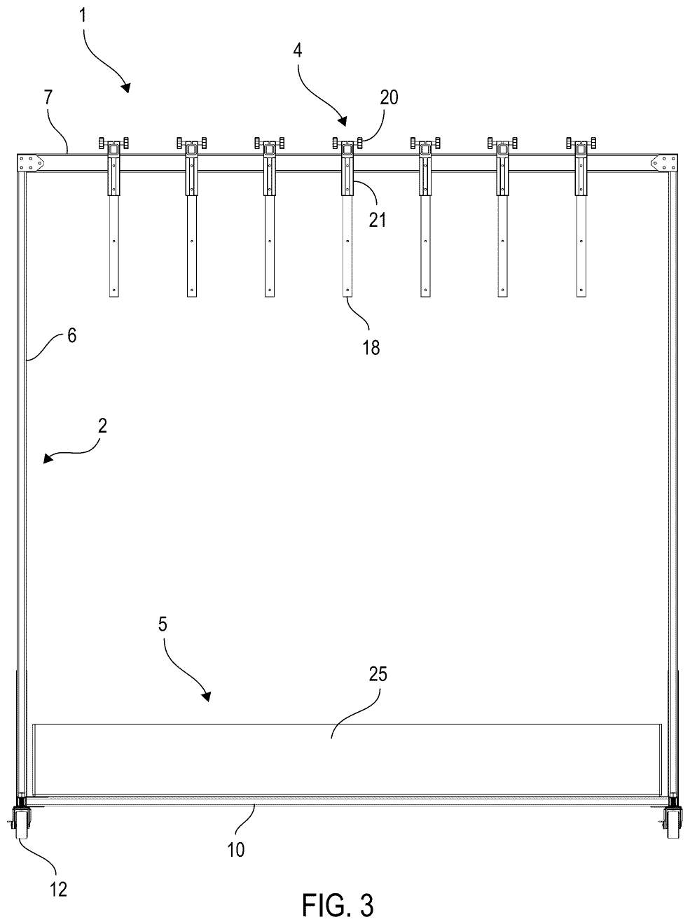

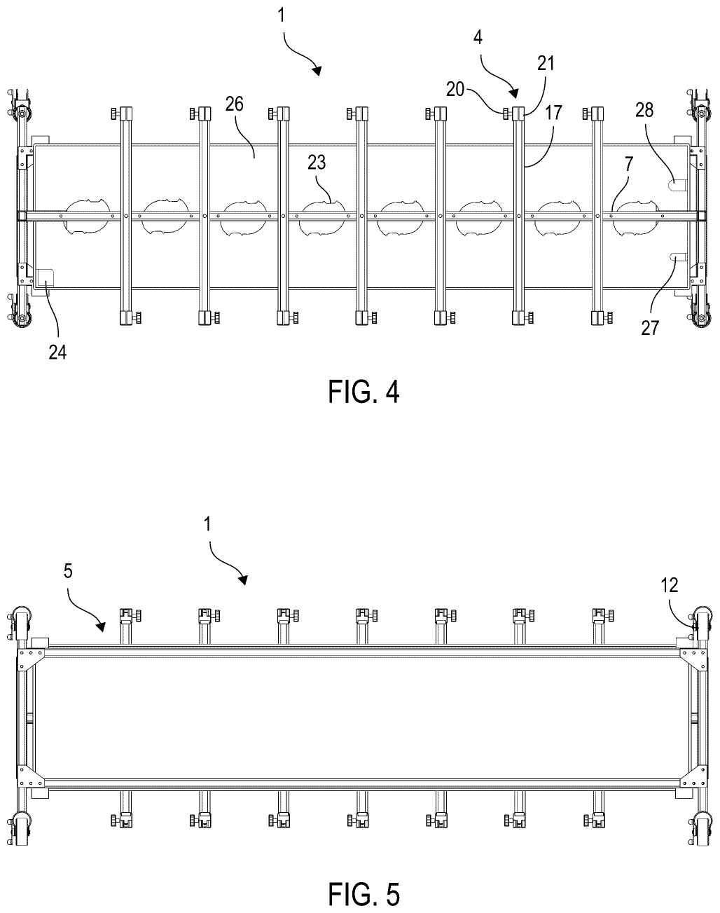

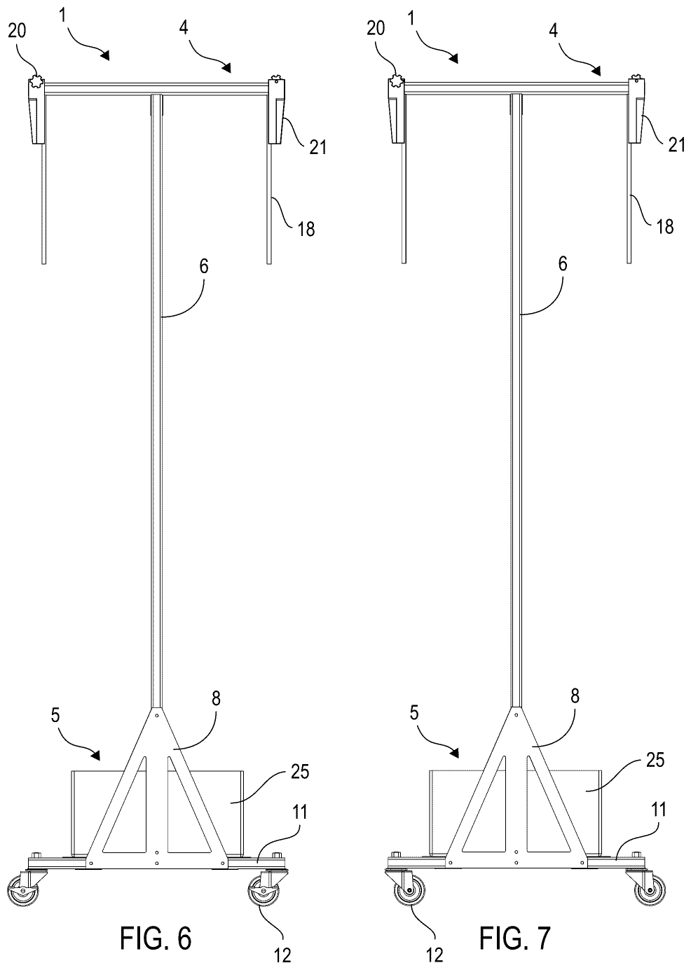

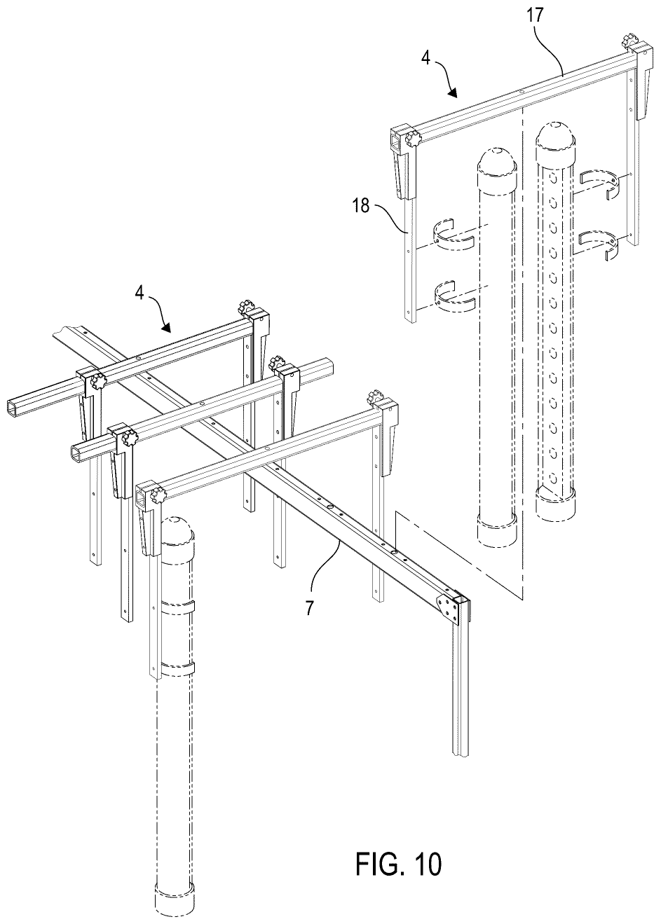

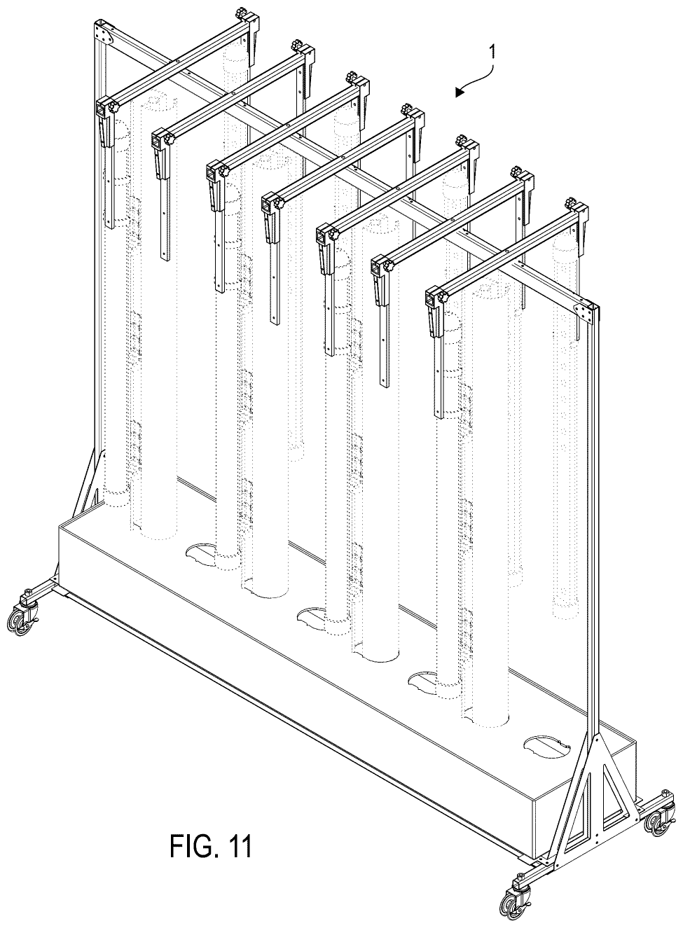

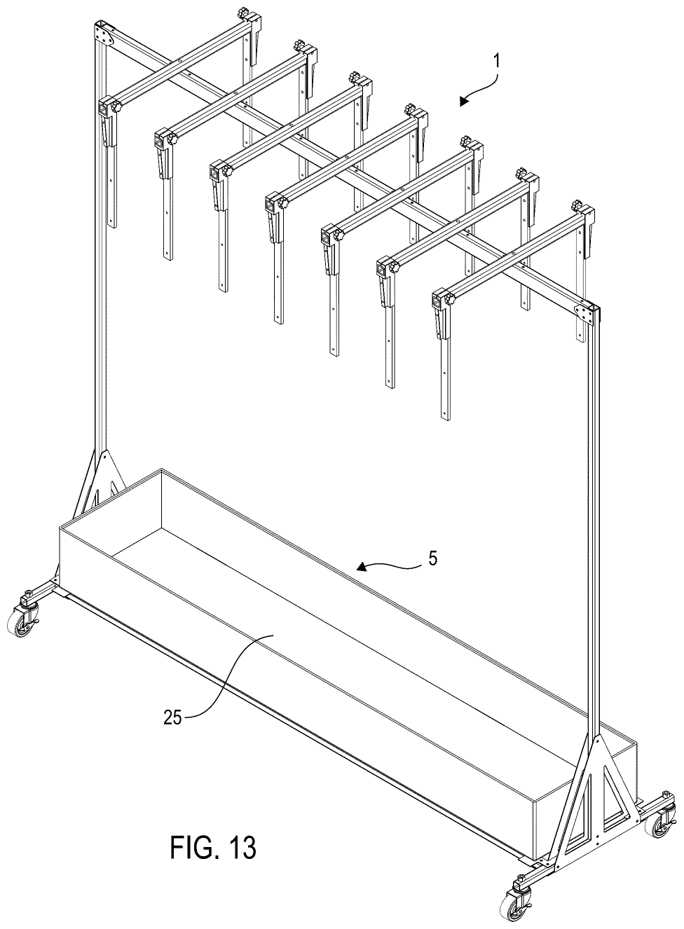

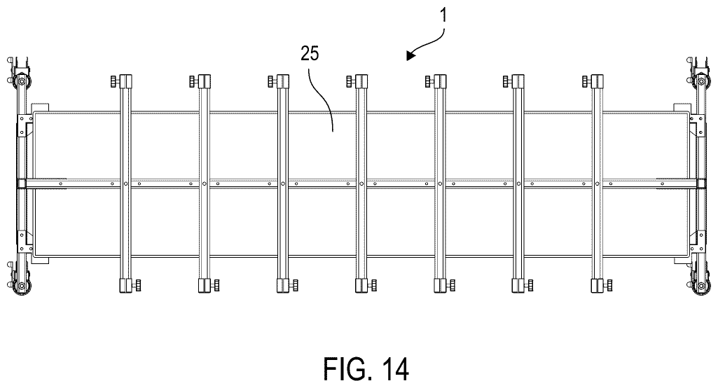

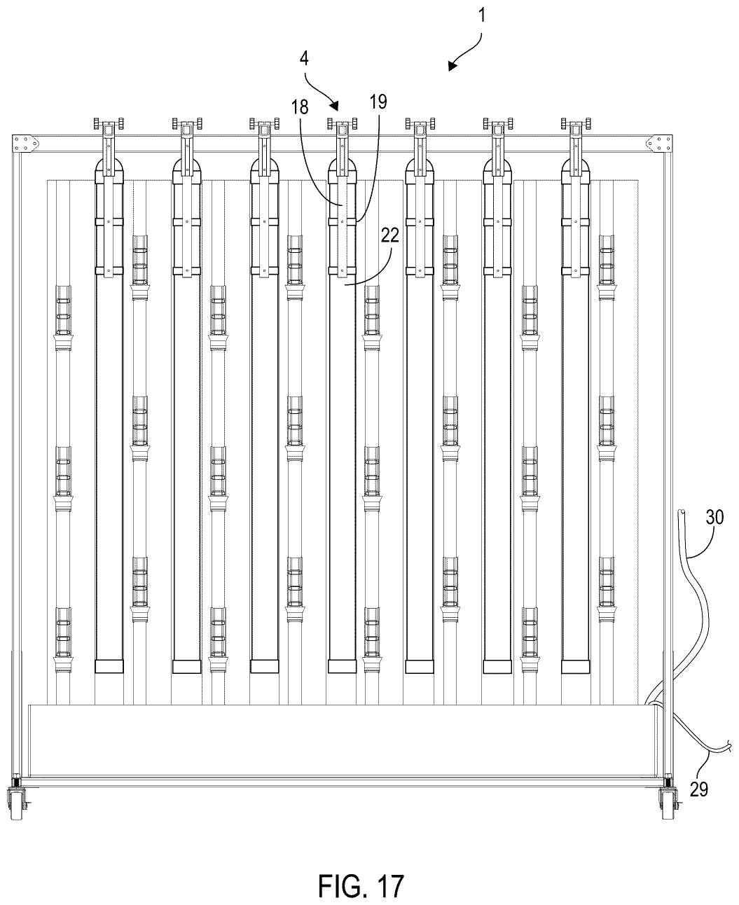

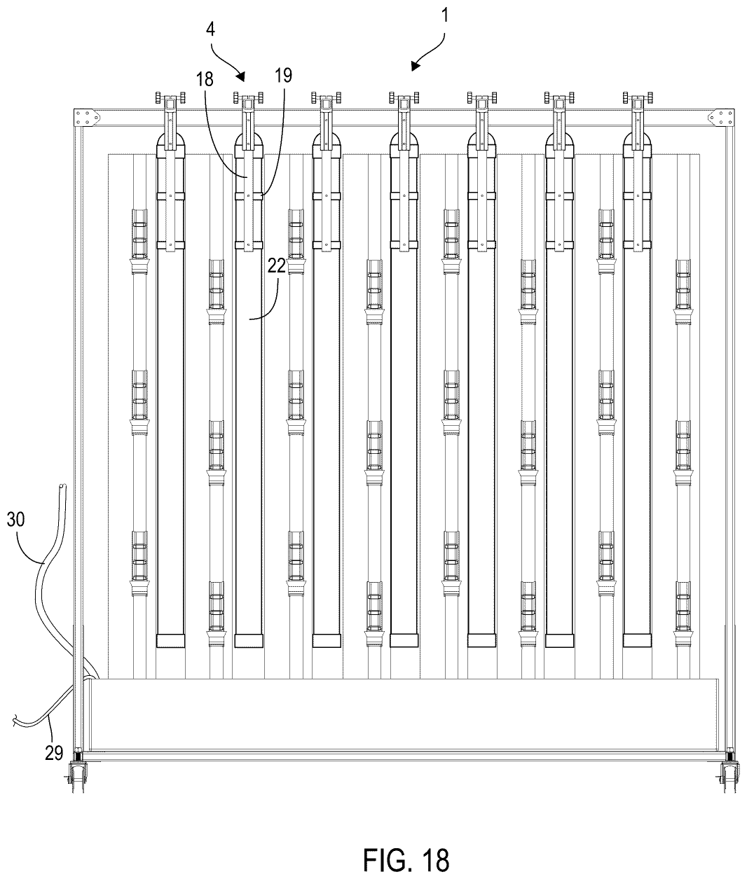

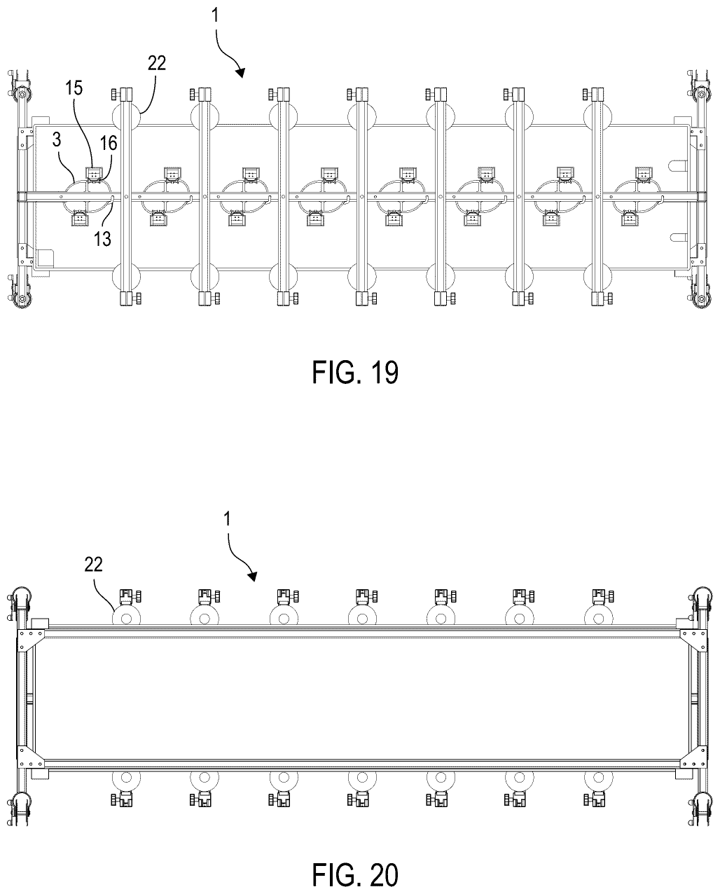

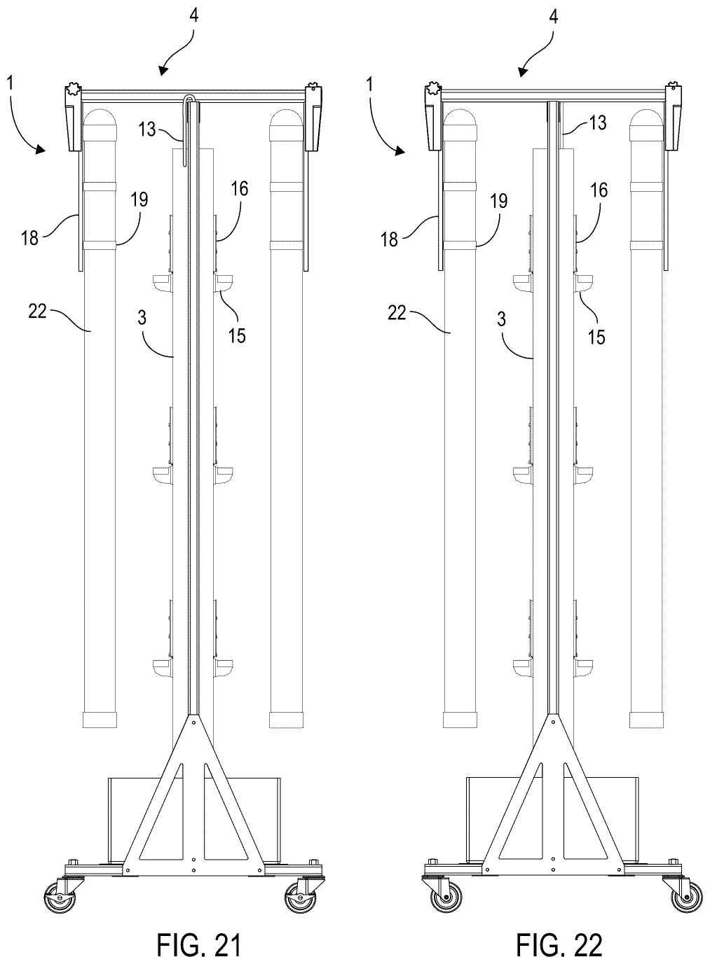

Referring more particularly to the drawing by characters of reference, FIGS. 1-24 depict embodiments of a rack assembly 1 having a frame 2, a plurality of light holders 4, and a storage container 5, wherein the storage container 5 has a lid defining a plurality of support bores 23 or pipe holders 23 spaced along a length of the lid for selectively receiving one of a plurality of pipes 3 or support members 3. As shown in the figures, the invention comprises (includes or has) a rack assembly for facilitating growing plants in vertical farming, wherein the plants may be arranged in a variety of configurations in a pot holder installed on a support member. The rack assembly is portable, adjustable, and customizable for growing a variety of plants, flowers, and food produce (collectively, “plants”) using aeroponic, hydroponic, or other means for growing and harvesting plants without the primary use of soil. The plants are fed nutrients and supplied water that are stored in a storage container, then fed or drawn through tubing to the plants. The size of the rack assembly may be customized for the individual user, with a smaller size suitable for general consumer use, and with a larger size suitable for commercial or large-scale use for growing a larger quantity of plants or food produce. The rack assembly is preferably configured for vertical farming to maximize space constraints for use in a variety of locations and environments.

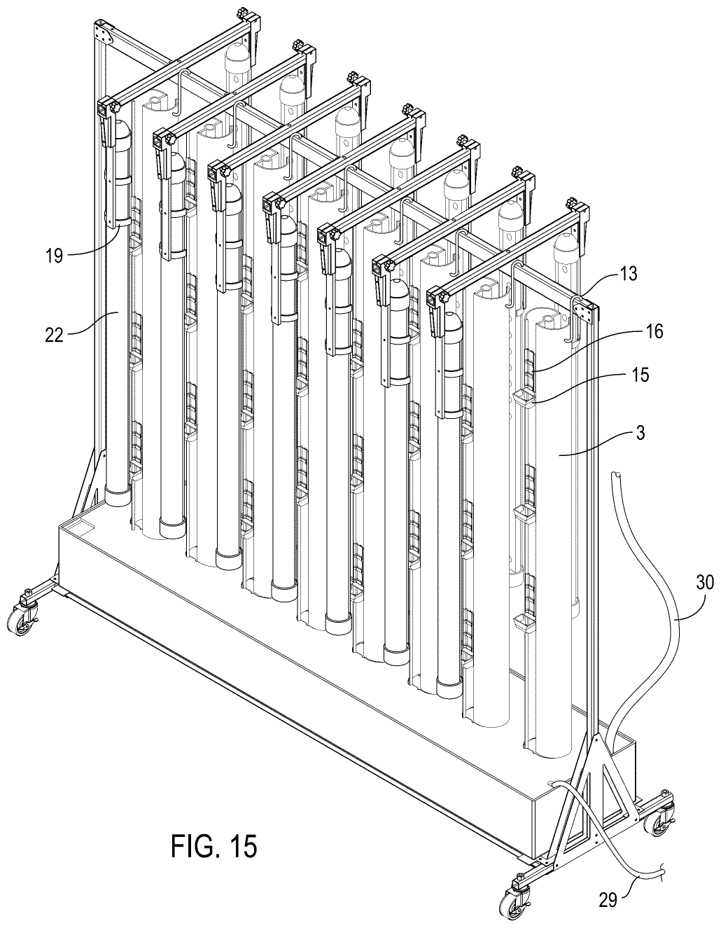

As shown in a first embodiment in FIG. 1, the rack assembly is depicted before installation of one or more pipes 3 or support members 3 for growing plants and of one or more light fixtures 22 for illuminating and providing warmth to the plants. Here, the rack assembly 1 comprises (includes or has) a frame 2 having a plurality of wheels 12 for portability of the rack assembly, a plurality of light holders 4, and a storage container 5 having a lid defining a plurality of pipe holders 23 therethrough for receiving one of a plurality of support members 3. As shown in FIG. 15, the rack assembly depicts an assembled configuration. Here, the rack assembly 1 further includes a plurality of upstanding pipes 3 or support members 3, each of which has a distal end coupled to or suspended within one of the corresponding plurality of pipe holders 23 defined in the lid of the storage container 5 and a proximal end coupled to the corresponding portion of the frame with a fastener or attachment member 13. In FIG. 15, the rack assembly further includes a plurality of light fixtures 22, each of which is selectively coupled to one of the plurality of light holders 4 for selective slidable adjustment inwardly or outwardly to the frame 2 and support members 3. The pipes 3 or support members 3 support one or more plant holders or pot holders 15, with each of the plant holders 15 having a plurality of selectively stackable, removable spacers 16 to extend the length of the plant holders installed within or onto the pipes 3.

As depicted in the figures, the frame 2 of the rack assembly 1 has two upstanding arms 6, an upper brace 7, a lower brace 8, and a base 9. The size of the frame may be selected based on the location of where the rack assembly is used. The frame is made of materials that minimize weight of the overall rack assembly while maintaining the strength and stability needed for supporting the weight of the pipes and the plants grown, and while still providing for mobility for the rack assembly to travel to different desired locations. The frame may be disassembled and assembled with ease by removing a plurality of fasteners or attachment members (not shown). Each of the two upstanding arms 6 of the frame 2 has a proximal, upper portion and a distal, lower portion. The proximal, upper portion of each of the upstanding arms 6 is fastened or otherwise connected to a corresponding end of the upper brace 7 of the frame 2 with fasteners. A bracket and fasteners are preferably used to abut the proximal, upper portion of each of the upstanding arms 6 and a corresponding end of the upper brace 7 of the frame 2. The distal, lower portion of each of the upstanding arms 6 is coupled to a corresponding lower brace 8 of the frame and is secured with fasteners.

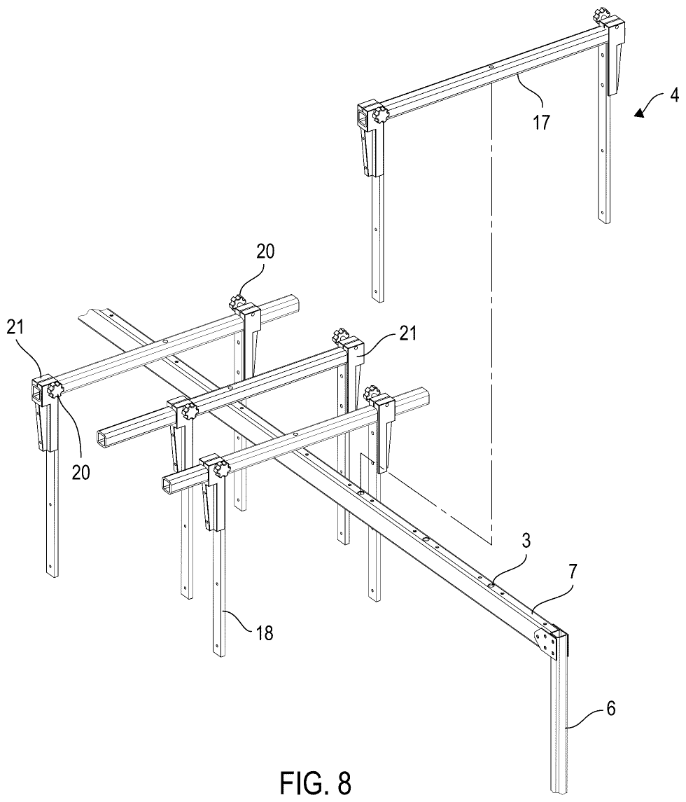

The upper brace 7 of the frame 2 is essentially an elongated bar or brace that extends the length of the frame 2. The upper brace has two opposing ends. Each end of the upper brace 7 is coupled to a corresponding proximal, upper portion of an upstanding arm 6 with a bracket and is secured with one or more fasteners. A top of the upper brace 7 defines a plurality of holes 33 therethrough, with the plurality of holes 33 being spaced apart along the length of the upper brace 7 for receiving one of a plurality of S-hooks 13 that couples the support members 3 to the frame 2. FIGS. 8, 10, and 23 depicts the upper brace 7 further defining a plurality of apertures 34 spaced along the top of the upper brace 7 for receiving one of the respective fasteners (not shown) to secure one of the plurality of light holders. The upper brace may be made of the same materials as the frame.

The lower brace 8 of the frame 2 provides support for the upper brace 6 and the two upstanding arms 6 of the frame. The bottom portion of the lower brace 8 is connected to the base 9 of the frame 2. The lower brace 8 defines a plurality of bores 32 for securing each upstanding arm 6 to the lower brace 8 and for securing the lower brace 8 to the base 9 of the frame 2. In preferred embodiment shown in the figures, the lower brace 8 is configured as unitary A-frame or triangle defining a slot therethrough for receiving the lower portion of each upstanding arm 6. In another embodiment, the lower brace 8 has a front plate and a rear plate, each of which is aligned with and coupled to the base 9 of the frame 2 in an upright position. The front plate and rear plate of the lower brace essentially sandwiches the lower portion of each of the upstanding arms then fastened near the upper point of the lower brace.

The base 9 of the frame 2 is formed from two opposing lateral segments 10 and two opposing end segments 11 connected together. The base of the frame supports the weight of the frame and the storage container. The base is configured for placement and support of the storage container on top of the base and secured with fasteners (not shown). In one embodiment, each end segment 11 of the base 9 preferably extends beyond the width of the spacing between the lateral segments 10. The configuration of the frame essentially forms a rectangular structure to help stabilize the structure. The frame further has a plurality of wheels 12 so the rack assembly can be portable yet balanced. Each end segment 11 further includes at least two wheels 12, one wheel at each end of the end segment 11. Each of the wheels preferably has a locking mechanism to prevent inadvertent rolling of the rack assembly. In one embodiment, each of the wheels preferably allows for zero-turn maneuverability.

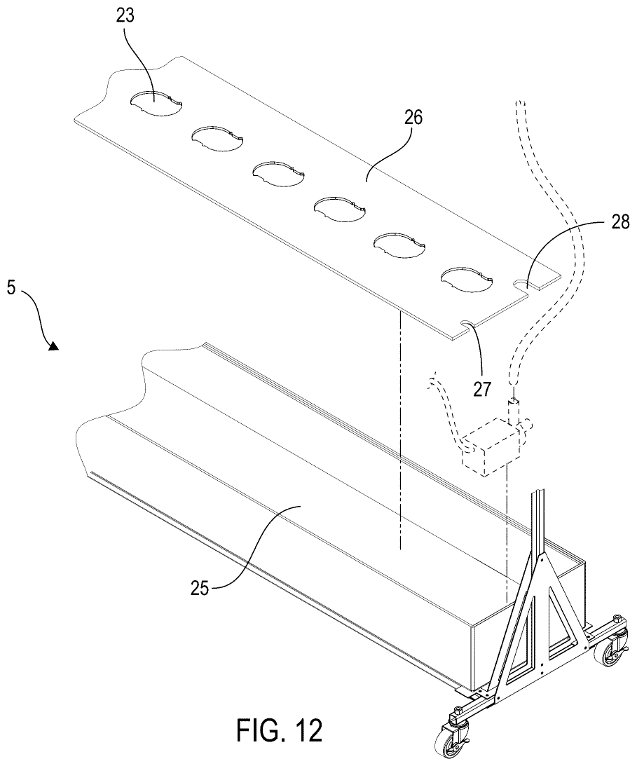

The storage container 5 comprises a container 25 and a removable lid 26. The storage container may further include a feeding source 30, nutrient media (not shown), and/or water (not shown). The container has a depth suitable for storing the feeding source and other components that may be used with the rack assembly for growing plants. The container 5 has a length suitable for use with a plurality of spaced apart pipes 3. The container is preferably made from materials that are waterproof or water resistant, reusable, and washable. FIG. 1 depicts that the lid 26 further defines a plurality of support bores 23 or pipe holders 23 each for selectively receiving and supporting one of the plurality of the pipes 3 or support members 3. Each of the plurality of support bores 23 is spaced apart along the length of the lid 26 and corresponds to each of the plurality of holes 33 defined in the upper brace of the frame 2. Each pipe 3 is inserted through the plurality of bores 23 in the lid 26, with a lower portion of the pipe 3 extending into the container 25. The lid 26 further defines at least two gaps 27, with both gaps being preferably located at one end of the lid 26, and a cutout 24 preferably located at the opposite end of the lid 26. As depicted in FIG. 12, the feeding source may include tubing, wiring, or other mechanisms placed inside the container 25, with the wiring, tubing, or other mechanisms being exposed through the one or more gaps 27 and the cutout in the lid 24. The container may further contain another compartment therein (not shown) to house at least the electrical components and wiring needed to actuate the light fixtures to produce light and any requisite heat. The rack assembly may further include a feeding source that may be stored and accessed from inside the storage container. The feeding source draws the nutrient media and/or water from the storage container up to the top of the support members to feed the plants within the pot holders.

Each pipe holder 23 is essentially an opening in the storage container lid 26. The pipe holder 23 (or bore 23) preferably has a configuration to which a tubular member, support member, or pipe 3 may be selectively and removably inserted therein. In one embodiment, a pipe 3 is inserted through the bore 23 with the bottom of the pipe 3 abutting the interior of the container 5. In another embodiment, the pipe 3 is inserted through the bore 23, with the pipe remaining suspended above the bottom of the container body, thereby leaving at least a spacing or gap between the bottom of the pipe 3 and the body of the container body 25.

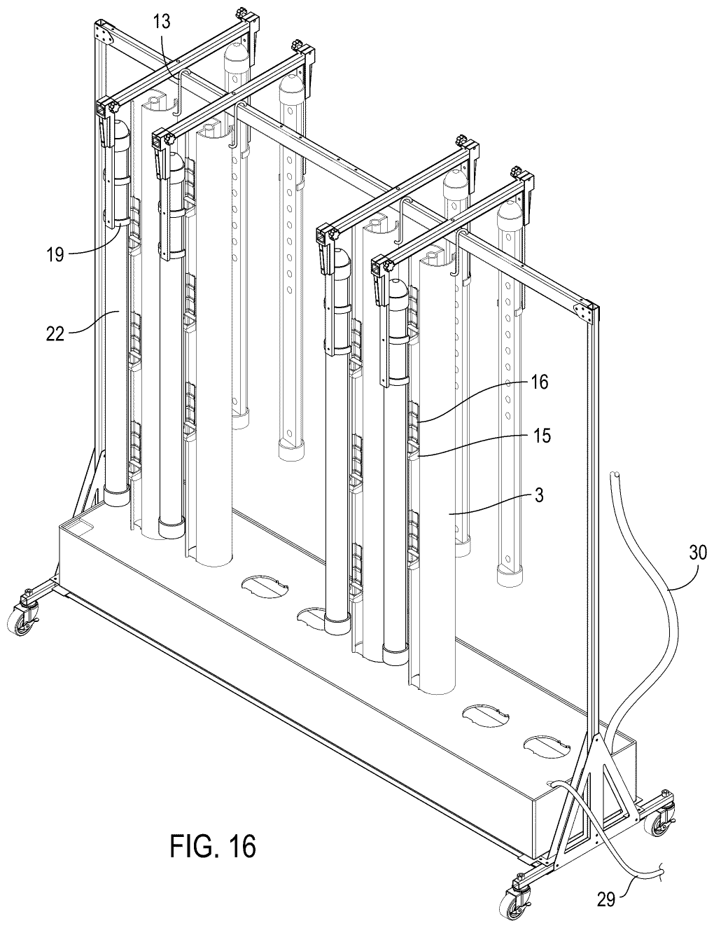

The rack assembly 1 may have one or more pipes 3 or support members 3 that are removably attachable to the frame 2 for growing plants. A user need not install or use a tubular member or pipe 3 at each of the pipe holders 23 in the storage container. In a preferred embodiment as shown in FIGS. 15, 17-22, the rack assembly comprises a plurality of pipes 3 coupled to the upper brace 7 of the frame 2 and inserted into the pipe holders 23. Alternatively, FIG. 16 depicts spacing between one or more of the installed pipes.

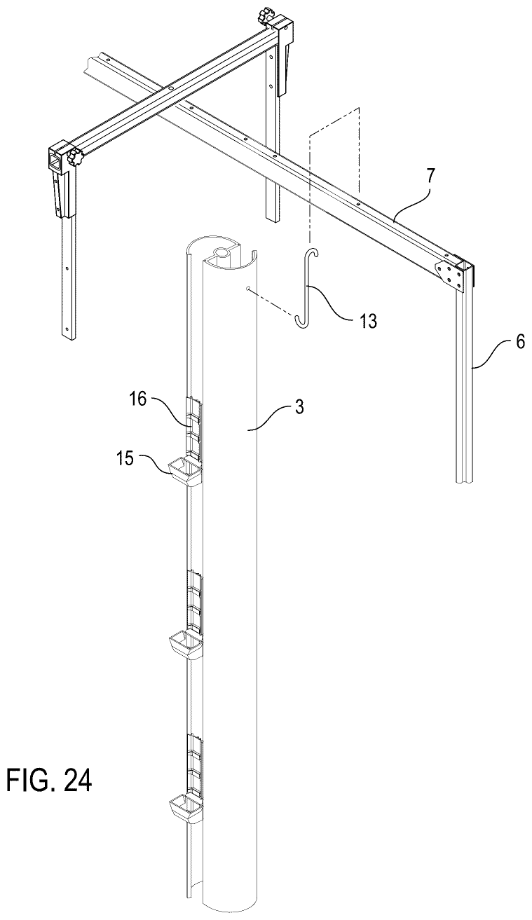

As depicted in FIG. 24, the tubular member or support member 3 is preferably a pipe 3 having a longitudinal, cylindrical body, with the body defining at least one opening or slot to receive one or more pot holders 15 having at least one pot 15 and one or more spacers 16. Other shapes or designs are contemplated. The support member body accommodates gradual opening and closing at the slot to receive one or more pot holders 15. Each pipe 3 further includes at least one hollow chamber extending therethrough along the length of the pipe 3. The upper portion of the pipe is secured to the frame using a fastener. More particularly, the upper portion of the pipe defines an aperture therethrough for engaging with a support member fastener. As shown in the figures, a preferred fastener is a hook member, and more preferably, an S-hook. Each pipe is sized to the preferred length depending on the distance between the container and upper part of the frame. Each pipe is lightweight and is weather-resistant or waterproof.

A hook member 13 is used with each support member 3 or pipe 3 to removably attach the support member 3 to the upper brace 7 of the frame 2. The hook member is preferably configured in an “S” shape. A lower portion of the S-hook 13 is inserted through an aperture defined near the upper portion of the support member 3. An upper portion of the S-hook 13 is inserted through the hole 33 defined in the upper brace 7 of the frame 2.

For the plant growth portion of the rack assembly, a plurality of plant holders or pot holders 15 are selectively arranged within the slot of the support member 3 body along the length of each support member 3. Each plant holder 15 has a pot 15. In the embodiment depicted in FIG. 24, the pot holder further comprises one or more spacers 16, with the spacers 16 being removably stackable upon each other and upon the pot 15. Once the combination of spacers and pot are stacked to a desired length, each of the plurality of pot holders may be removably arranged and spaced along the length of the support member as shown in FIGS. 15, 16, and 24. Plants may be grown in the pot for later harvesting in vertical farming. Nutrients arrive at the plants through the feeding source stored in the storage container and fed through the tubing and/or hoses to the pot holders.

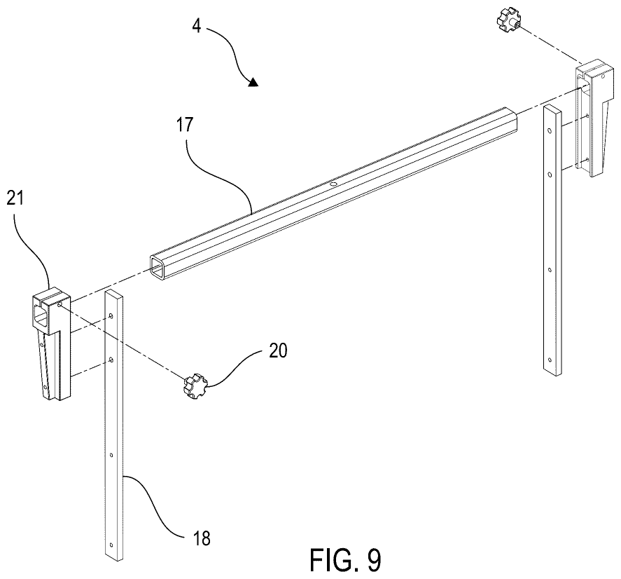

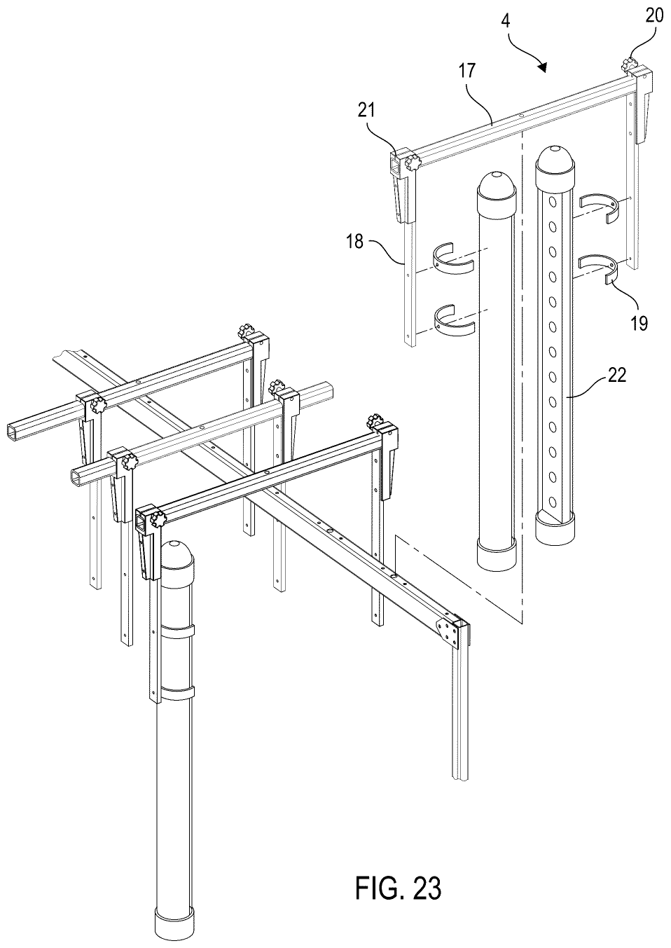

As shown in at least in FIGS. 8-10 and 23, each light holder 4 of the rack assembly 1 comprises a cross bar 17, two fixture brackets 18 each of which abuts perpendicular an end of the cross bar 17 for supporting a light fixture 22, and a slidable column 21 having an adjustable member 20. The light holder 4 may further include a plurality of clamps 19 and one or more light fixtures 22. Each light holder can support two light fixtures in a parallel configuration as shown in FIG. 15. As shown in FIGS. 9 and 23, the cross bar 17 of the light holder is an elongated bar having two opposing ends with a central section of the cross bar defining at least one hole therethrough. The cross bar 17 is mounted to the upper brace 7 of the frame 2 with fasteners insertable through the hole of the cross bar 17 and one of the corresponding holes in the upper brace 7 of the frame 2 as shown in at least FIGS. 8 and 23. In one embodiment, the cross bar is an open-ended hollow tube.

Each slidable column 21 of the light holder 4 is removably coupled to one of the ends of the cross bar 17. The column 21 has an upper portion configured to slidably receive one of the ends of the cross bar 17; a lower portion having a rear portion recessed within the column 17; a tapered front portion; and an adjustable member 20. The column may further define a plurality of holes, with one hole defined in the upper portion of the column and being adapted to receive a fastener for securing the adjustable member 20. The column 17 may further have at least two spaced part holes defined in the lower portion of the column and adapted to receive fasteners securing the column 17 to the fixture bracket 18. The light holder, and consequently the light fixture, may be slidably adjusted inwardly or outwardly along the length of the cross bar depending on the needs of the particular plants being grown in the pipes. During slidable adjustment of the light holder, the light holder selectively moves inwardly toward or outwardly away from the frame and support members containing the pot holder. For example, if the desired plants need a more direct light source or heat producing light source, the adjustable member is loosened to allow the column to slide inwardly and closer toward the pipe or support member, and consequently, the pot holder. Conversely, the column may be slid outwardly along the cross bar and further away from the pipe for a less direct source of light. This embodiment allows selective adjustment of each individual light fixtures installed on the rack assembly.

The bracket 18 of the light holder 4 is essentially a plate defining a plurality of spaced apart holes. The bracket is coupled to the column by abutting the rear of the column's recessed portion against the plate. As shown in FIG. 9, two of the plurality of holes are located at an upper portion of the bracket and are spaced closer together than the other holes located at the central and lower portions of the bracket. In a preferred embodiment, the adjustable member is a knob. The central and lower holes of the bracket are adapted to receive one of a plurality of light fixture clamps.

Each light fixture 22 may be selected from a variety of grow lights, fluorescent lights, solar lights, and more. The light fixture 22 is coupled to the bracket 18 with one or more of the clamps 19. The distance between the light source 22 and the support member 3 containing the pot holder 15 may be selectively adjustable by loosening the knob, then slidably adjusting the light holder inwardly or outwardly in relation to the support member. After reaching the desired distance for optimal light illuminating the plants within the pot holder, the knob is tightened on the column.

To assemble the rack assembly for use in growing plants vertically, the frame of the rack assembly is moved to a desired location then secured by locking each wheel to prevent excessive inadvertent movement. The lid of the container is removed and the food source for the plants is put inside the container. The requisite tubing and hoses are connected and fed through the container and out the respective openings, gaps, bores, or holes, in the lid of the container. When applicable, the electrical source is also provided. The light fixtures 22 may be installed by holding each light fixture in an upright or vertical position and securing the light fixture against the bracket of the light holder with one or more clamps 19. Each support member or pipe 3 is installed onto the rack assembly 1 by selectively inserting one end of the support member 3 into the hole 23 and securing the upper end of the support member 3 to the S-hook 13 to the frame as shown in FIG. 16. One or more pot holders having the desired number of spacers is installed on the support member. The desired number of support members are installed in the same manner on the frame. The desired number of light fixtures for the respective support members are also installed. Preferably, two light fixtures are coupled to an individual light holder per support member or pipe as shown in the figures. When applicable, the light fixtures are further connected to an electrical source to provide power to each light fixture. Seedlings or plants may be added to the pot holder before or after installing the pot holder on the pipe. Each light fixture may be selectively and slidably adjusted along the cross bar of the light holder depending on the lighting and heating needs of the individual plants on a particular pipe. The position of the light fixture is secured with the adjustable knob.

The plants are fed with nutrients and water, as applicable, from the food and nutrients stored within the storage container. The feeding tubing and hoses may further be coupled to the top of pipes or to the upper part of the frame to dispense the nutrients and water to the plants, as needed. This rack system is preferably used for vertical growth and harvesting of plants, flowers, and produce while using minimal to no soil.

In one embodiment, the invention is a rack assembly for growing plants, the rack assembly comprising (including or having): a frame for supporting at least one support member, at least one light holder, and a storage container; the storage container having a container body having a removable lid, with the lid defining at least one pipe holder; the at least one support member having an upper portion removably coupled to the frame with a support member fastener and a lower portion for removably inserting into the at least one pipe holder of the storage container; at least one pot holder for holding one or more plants, with the at least one pot holder being selectively arranged and removably attached to the at least one support member; and the at least one light holder having at least one light fixture removably attachable to the at least one light holder for providing a light source and a heat source to the plants growing within the at least one pot holder, and with the at least one light holder being selectively, slidably adjustable inwardly to or outwardly from the frame.

In another embodiment, the invention is a portable rack assembly for growing and harvesting plants, the rack assembly comprising: a frame having an upper brace, a lower brace, two upstanding arms, and a base, with the frame for supporting a plurality of support members, a plurality of light holders, and a storage container; the plurality of support members, each having a longitudinal body defining at least one slot therein; a plurality of pot holders, each having a pot for growing the plants; a plurality of light fixtures coupled to a corresponding of the plurality of light holders for providing a light source and warmth to the plants growing in the plurality of pot holders; the plurality of light holders, each having an adjustable, slidably column for moving the plurality of light holders and the plurality of light fixtures inwardly to or outwardly from the plurality of support members containing the plurality of pot holders growing the plants; the storage container having a removable lid defining a plurality of pipe holders, with a distal end of each of the plurality of support members being selectively inserted within the pipe holder and a proximal end of each of the plurality of support members being coupled to the frame with a fastener.

In yet another embodiment, the invention is a rack assembly for growing and harvesting plants, the rack assembly comprising:
a. a frame comprising an upper brace defining a plurality of holes and a plurality of apertures each of which is spaced along a length of the upper brace, with the frame further comprising two lower braces, two opposing upstanding arms, and a base, with a proximal end of each of the two opposing upstanding arms being attached to an end of the upper brace and a distal end of each of the two opposing upstanding arms being attached to an end of the base and to each of the corresponding lower braces;
b. a plurality of support members, each of which is selectively coupled to the frame and to a storage container, with each of the plurality of support members comprising a longitudinal body defining at least one slot therein engaging with at least one of a plurality of pot holders, with an upper portion of each of the plurality of support members defining an aperture for receiving a support member fastener for fastening the plurality of support members to the upper brace of the frame;
c. the plurality of pot holders, each being selectively and removably attached within the at least one slot of one of the plurality of support members and arranged along a length of the longitudinal body of the plurality of support members, with each of the plurality of pot holders having a pot for holding and growing plants and a plurality of spacers, with the pot further defining a rear opening to accommodate drainage and growth of plant roots, and with one or more of the plurality of spacers being selectively stackable on top of the pot and on one or more of the plurality of spacers for providing additional spacing among the plurality of pot holders assembled within the at least one slot of the plurality of support members;
d. a plurality of light fixtures for providing a light source and a heat source for the plants grown in one or more of the plurality of pot holders;
e. a plurality of light holders, wherein each of the plurality of light holders is selectively coupled to the upper brace of the frame and for holding one of the plurality of light fixtures, and wherein each of the plurality of light holders is selectively, slidably adjustable to direct the light source and the heat source for the plants;
f. a storage container having a container body, a removable lid, and one or more tubing, and further defining a plurality of pipe holders spaced along a length of the lid for engaging with the plurality of support members.

Those skilled in the art who have the benefit of this disclosure will appreciate that it may be used as the creative basis for designing devices or methods like those disclosed herein, or to design improvements to the invention disclosed herein; such new or improved creations should be recognized as dependent upon the invention disclosed herein, to the extent of such reliance upon this disclosure.

I claim:

1. A rack assembly for growing plants, the rack assembly comprising:
a. a frame for supporting at least one support member, at least one light holder, and a storage container;
b. the storage container having a container body having a removable lid, with the lid defining at least one pipe holder;
c. the at least one support member having an upper portion removably coupled to the frame with a support member fastener and a lower portion for removably inserting into the at least one pipe holder of the storage container;
d. at least one pot holder for holding one or more plants, with the at least one pot holder being selectively arranged and removably attached to the at least one support member; and
e. the at least one light holder having at least one light fixture removably attachable to the at least one light holder for providing a light source and a heat source to the plants growing within the at least one pot holder, and with the at least one light holder being selectively, slidably adjustable inwardly to or outwardly from the frame.

2. The rack assembly of claim 1, the frame further comprising two upstanding arms, an upper brace, a lower brace, and a base, with the upper brace defining a plurality of holes therethrough and spaced apart along a length of the upper brace, with each of the plurality of holes for receiving one of the support member fasteners for coupling the at least one support member to the upper brace of the frame, and with the base supporting the storage container.

3. The rack assembly of claim 1, the frame further comprising at least two wheels for portability of the rack assembly.

4. The rack assembly of claim 1, the storage container further comprising a feeding source, with the lid of the storage container further defining at least two gaps and defining a cutout, with the feeding source having at least one tubing insertable through one of the at least two gaps or the cutout in the lid, and with the feeding source further having nutrients selected from the group consisting of, water, nutrients, nutrient media, and combinations thereof, wherein the nutrients are drawn through the feeding source to the upper portion of the at least one support member for dispersing to the one or more plants growing in the at least one pot holder.

5. The rack assembly of claim 1, the support member further comprising a longitudinal body defining at least one slot therein for supporting the at least one pot holder.

6. The rack assembly of claim 1, each support member fastener removably coupling the at least one support member to the frame comprising an S-hook fastener, wherein the fastened at least one support member is insertable through the at least one pipe holder and suspended within the storage container.

7. The rack system of claim 5, the at least one pot holder comprising a pot for holding one or more plants, with one or more of the at least one pot holder being selectively arranged within the at least one slot of the at least one support member, with the plants being selectively provided with a light source and warmth from the at least one light fixture wherein the at least one light fixture is selectively slidable inwardly or outwardly from the at least one pot holder and the frame for optimal growth of the plants.

8. The rack system of claim 7, the at least one pot holder further comprising at plurality of spacers, each of which is selectively and removably stackable upon one or more of the plurality of spacers and stackable upon the pot for adding separation and space among a plurality of the at least pot holders being arranged within the at least one slot of the at least one support member.

9. The rack system of claim 5, the longitudinal body of the at least one support member defining the at least one slot comprising a plurality of the at least one slots configured around the longitudinal body of the support member.

10. The rack system of claim 8, the rack system further comprising a plurality of the at least one light holders and a plurality of the at least one light fixtures, with each of the at least one light holders having a cross bar perpendicular to the upper brace of the frame, two fixture brackets wherein each extends downwardly from an end of the cross bar, and a slidable column, with each of the at least one light holders being aligned with and parallel to each of the holes in the upper brace of the frame corresponding to placement of each of the at least one support member, wherein one of the at least one light fixture is selectively attached to the fixture bracket of the at least one light holder for selectively attaching one or more of the at least one light fixtures near a corresponding of the at least one support member to selectively provide a light source and heat source to the plants growing in the at least one pot holder.

11. A portable rack assembly for growing and harvesting plants, the rack assembly comprising:
a. a frame having an upper brace, a lower brace, two upstanding arms, and a base, with the frame for supporting a plurality of support members, a plurality of light holders, and a storage container;
b. the plurality of support members, each having a longitudinal body defining at least one slot therein;
c. a plurality of pot holders, each having a pot for growing the plants;
d. a plurality of light fixtures coupled to a corresponding of the plurality of light holders for providing a light source and warmth to the plants growing in the plurality of pot holders;
e. the plurality of light holders, each having an adjustable, slidably column for moving the plurality of light holders and the plurality of light fixtures inwardly to or outwardly from the plurality of support members containing the plurality of pot holders growing the plants;
f. the storage container having a removable lid defining a plurality of pipe holders, with a distal end of each of the plurality of support members being selectively inserted within the pipe holder and a proximal end of each of the plurality of support members being coupled to the frame with a fastener.

12. A rack assembly for growing and harvesting plants, the rack assembly comprising:
a. a frame comprising an upper brace defining a plurality of holes and a plurality of apertures each of which is spaced along a length of the upper brace, with the frame further comprising two lower braces, two opposing upstanding arms, and a base, with a proximal end of each of the two opposing upstanding arms being attached to an end of the upper brace and a distal end of each of the two opposing upstanding arms being attached to an end of the base and to each of the corresponding lower braces;
b. a plurality of support members, each of which is selectively coupled to the frame and to a storage container, with each of the plurality of support members comprising a longitudinal body defining at least one slot therein engaging with at least one of a plurality of pot holders, with an upper portion of each of the plurality of support members defining an aperture for receiving a support member fastener for fastening the plurality of support members to the upper brace of the frame;
c. the plurality of pot holders, each being selectively and removably attached within the at least one slot of one of the plurality of support members and arranged along a length of the longitudinal body of the plurality of support members, with each of the plurality of pot holders having a pot for holding and growing plants and a plurality of spacers, with the pot further defining a rear opening to accommodate drainage and growth of plant roots, and with one or more of the plurality of spacers being selectively stackable on top of the pot and on one or more of the plurality of spacers for providing additional spacing among the plurality of pot holders assembled within the at least one slot of the plurality of support members;
d. a plurality of light fixtures for providing a light source and a heat source for the plants grown in one or more of the plurality of pot holders;
e. a plurality of light holders, wherein each of the plurality of light holders is selectively coupled to the upper brace of the frame and for holding one of the plurality of light fixtures, and wherein each of the plurality of light holders is selectively, slidably adjustable to direct the light source and the heat source for the plants;
f. a storage container having a container body, a removable lid, and one or more tubing, and further defining a plurality of pipe holders spaced along a length of the lid for engaging with the plurality of support members.

13. The rack system of claim 13, the rack system further comprising nutrient media stored within the storage container and drawn through the one or more tubing extending upwardly from the storage container to the top of the support member for dispersal to the plurality of pot holders.
